(19) United States
(12) Patent Application Publication
(10) Pub. No.: US 2018/0087505 A1
(43) Pub. Date: Mar. 29, 2018

(54) FORKLIFT, INTERNAL GEAR PUMP, AND AXIAL COMPENSATION COMPONENT THEREOF

(71) Applicant: BYD COMPANY LIMITED, Shenzhen (CN)

(72) Inventors: Anqing ZHANG, Shenzhen (CN); Liyu ZHANG, Shenzhen (CN); Xiaofeng LU, Shenzhen (CN); Qiang GUO, Shenzhen (CN)

(21) Appl. No.: 15/809,698

(22) Filed: Nov. 10, 2017

Related U.S. Application Data
(63) Continuation of application No. PCT/CN2016/081577, filed on May 10, 2016.

(30) Foreign Application Priority Data
May 11, 2015 (CN) 201510237569.4

(51) Int. Cl. F04C 2/10; F04C 2/08; F04C 15/00

(52) U.S. Cl. CPC F04C 2/101; F04C 2/084; B66F 9/075; F04C 15/0088; F04C 15/0007

(57) ABSTRACT

The present disclosure provides a forklift, an internal gear pump, and an axial compensation component thereof. The axial compensation component for the internal gear pump is configured to be sandwiched between a pump cover of the internal gear pump and a gear pair of the internal gear pump, and the axial compensation component includes: a floating side plate; and a floating sleeve fixed at a side of the floating side plate far away from the gear pair, in which a part of the floating sleeve is configured to extend into an oil storage tank of the pump cover, the oil storage tank is configured to be in communication with a high-pressure oil area of the internal gear pump, and the floating side plate is configured to press tightly against the gear pair under an oil pressure in the oil storage tank.

### TECHNICAL FIELD

The present disclosure relates to a field of machine manufacturing, and in particular, to an axial compensation component for an internal gear pump, an internal gear pump having the axial compensation component and a forklift having the internal gear pump.

### BACKGROUND

A floating side plate is sandwiched between a gear pair and a pump cover. When an internal gear pump works, abrasion occurs in the floating side plate, and therefore, axial compensation is needed. An existing axial compensation member is mainly an elastic member, and provides axial compensation based on resilience that is generated by the axial compensation member after the axial compensation member is compressed. Such axial compensation can only satisfy compensation for a relatively small axial gap, and will become ineffective when an axial gap exceeds a deformation amount of the axial compensation member, which thus causes decreased volumetric efficiency of the internal gear pump and greatly affects performance of the internal gear pump. Besides, the existing axial compensation member has a complex structure and a high manufacturing cost, and still has much room for improvement.

### SUMMARY

The present disclosure aims to resolve, at least to some degree, one of the technical problems in the related art. In view of this, an objective of the present disclosure is to provide an axial compensation component for an internal gear pump, which has a large axial compensation range.

Another objective of the present disclosure is to provide an internal gear pump having the foregoing axial compensation component.

Still another objective of the present disclosure is to provide a forklift having the foregoing internal gear pump.

Embodiments of a first aspect of the present disclosure provide an axial compensation component for an internal gear pump, configured to be sandwiched between a pump cover of the internal gear pump and a gear pair of the internal gear pump, and the axial compensation component includes: a floating side plate; and a floating sleeve fixed on a side of the floating side plate away from the gear pair, wherein a part of the floating sleeve is configured to extend into an oil storage tank of the pump cover, the oil storage tank is configured to be in communication with a high-pressure oil area of the internal gear pump, and the floating side plate is configured to press tightly against the gear pair under an oil pressure in the oil storage tank.

The axial compensation component for the internal gear pump according to the embodiments of the first aspect of the present disclosure has a greatly increased axial compensation range, can achieve axial compensation for a relatively large gap, and is easy to assemble.

In addition, the axial compensation component for the internal gear pump according to the foregoing embodiments of the present disclosure may further have the following additional technical features.

Further, a guide groove configured to be in communication with the high-pressure oil area of the internal gear pump is formed in a side, which faces the gear pair, of the floating side plate, and an installation groove is formed in a side, which faces the floating sleeve, of the floating side plate; and a part of the floating sleeve is disposed inside the installation groove via an interference fit, the floating sleeve is provided with a through hole running through the floating sleeve along an axial direction of the floating sleeve, and the through hole is in communication with the guide groove.

Preferably, the floating sleeve includes: an installation part, disposed inside the installation groove via the interference fit; and a support part, having a first end connected to the installation part and a second end extending into the oil storage tank.

Preferably, a seal component is arranged between an inner circumferential wall of the oil storage tank and the support part, to seal a gap between the inner circumferential wall of the oil storage tank and the support part.

Further, a groove that is recessed radially inward and an installation boss that protrudes radially outward are provided at an outer circumferential wall of the support part, and a side of the installation boss abuts against the floating side plate; and the seal component includes: a seal ring arranged in the groove; and a seal sleeve sleeved on the support part and sandwiched between the seal ring and the installation boss.

Preferably, the seal ring is an O-shaped seal ring.

Preferably, the floating side plate is configured as an arc-shaped plate, a plurality of floating sleeves are provided, and the plurality of floating sleeves are arranged and spaced apart from each other along a circumferential direction of the arc-shaped plate.

Embodiments of a second aspect of the present disclosure provide an internal gear pump, and the internal gear pump includes: a gear pair including an annular gear and a gear shaft meshed with each other, and defining a high-pressure oil area and a low-pressure oil area between the annular gear and the gear shaft; a pump cover having an oil storage tank formed in an end face, which faces the gear pair, of the pump cover; and an axial compensation component according to the embodiments of the first aspect of the present disclosure, in which a part of the floating sleeve extends into the oil storage tank, the oil storage tank is in communication with the high-pressure oil area of the internal gear pump, and the floating side plate presses tightly against the gear pair under an oil pressure in the oil storage tank.

The internal gear pump according to the embodiments of the second aspect of the present disclosure can achieve axial compensation for a relatively large gap, and volumetric efficiency of the internal gear pump is not affected when the floating side plate has large abrasion, and therefore, the internal gear pump has a long service life. Besides, the axial compensation component of the internal gear pump is easy to assemble, and production efficiency thereof is high.

In addition, the internal gear pump according to the foregoing embodiments of the present disclosure may further have the following additional technical features.

Further, two pump covers are provided, and the two pump covers include a front pump cover arranged at a front side of the gear pair and a rear pump cover arranged at a rear side of the gear pair; two axial compensation components are provided, one of the two axial compensation components is arranged between the front pump cover and the front side of the gear pair, and the other thereof is arranged between the rear pump cover and the rear side of the gear pair.

Further, the internal gear pump includes a radial seal compensation component arranged between the annular gear and the gear shaft, and the radial seal compensation component includes: an outer crescent member abutting against the annular gear; an inner crescent member abutting against the gear shaft, in which a first gap in communication with the high-pressure oil area and a second gap in communication with the low-pressure oil area are defined between the outer crescent member and the inner crescent member; a spring sheet arranged in the first gap and having two ends elastically abutting against the outer crescent member and the inner crescent member respectively; and a seal bar having a cylindrical shape and arranged between the outer crescent member and the inner crescent member, to isolate the high-pressure oil area from the low-pressure oil area.

Embodiments of a third aspect of the present disclosure provide a forklift, and the forklift includes the internal gear pump according to the embodiments of the second aspect of the present disclosure.

The forklift according to the embodiments of the third aspect of the present disclosure has same advantages as the internal gear pump according to the embodiments of the second aspect of the present disclosure, which are not described herein again.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a sectional view of an internal gear pump according to an embodiment of the present disclosure;

FIG. 2 is a view of an internal gear pump along an A-A direction in FIG. 1, in which a floating side plate is shown;

FIG. 3 is a view of an internal gear pump along an A-A direction in FIG. 1, in which a floating side plate is not shown;

FIG. 4 is an enlarged view of portion B in FIG. 1;

FIG. 5 is a front view of an axial compensation component according to an embodiment of the present disclosure;

FIG. 6 is a right view of an axial compensation component according to an embodiment of the present disclosure;

FIG. 7 is a sectional view of a floating sleeve according to an embodiment of the present disclosure;

FIG. 8 is a front view of a floating side plate according to an embodiment of the present disclosure;

FIG. 9 is a rear view of a floating side plate according to an embodiment of the present disclosure;

FIG. 10 is a sectional view of a seal sleeve according to an embodiment of the present disclosure; and

FIG. 11 is a schematic view showing a cross section of a seal sleeve according to an embodiment of the present disclosure.

### REFERENCE SIGNS

1000: internal gear pump;

100: axial compensation component;

110: floating side plate; 111: guide groove; 112: installation groove; 113: installation hole;

120: floating sleeve; 121: support part; 1211: groove; 1212: installation boss; 122: installation part; 123: through hole;

130: seal component; 131: seal ring; 132: seal sleeve;

200: gear pair; 210: annular gear; 220: gear shaft;

300: pump cover; 301: front pump cover; 302: rear pump cover; 303: small pump cover; 310: oil storage tank;

400: radial seal compensation component; 410: outer crescent member; 420: inner crescent member; 430: spring sheet; 440: seal bar;

500: pump body; 600: sliding bearing; 700: mechanical seal element;

I: high-pressure oil area; II: low-pressure oil area; III: first gap; IV: second gap.

### DETAILED DESCRIPTION

Embodiments of the present disclosure are described in detail below. Examples of the embodiments are shown in the accompanying drawings. Same or similar reference signs represent same or similar elements or elements having same or similar functions. The following embodiments described with reference to the accompanying drawings are exemplary, are intended to explain the present disclosure, and shall not be understood as limitations on the present disclosure.

In the descriptions of the present disclosure, it should be understood that directions or position relationships indicated by terms such as “on”, “under”, “front”, “rear”, “vertical”, “horizontal”, “top”, “bottom”, “inner”, “outer”, “axial”, “radial”, and “circumference” are based on directions or position relationships shown in the accompanying drawings. The terms are merely intended for ease and simplicity of description of the present disclosure, and do not indicate or imply that represented apparatuses or elements need to be in particular positions or constructed and operated in particular positions. Therefore, the terms shall not be understood as limitations on the present disclosure.

In addition, the terms “first” and “second” are merely intended for description, and do not indicate or imply relative importance or implicitly show a quantity of indicated technical features. Therefore, features limited by using “first” and “second” may explicitly or implicitly include at least one of the features. In the descriptions of the present disclosure, “a plurality of” means at least two, for example, two or three, unless otherwise clearly limited.

In the present disclosure, unless otherwise clearly stated and limited, terms such as “installation”, “connect”, “connection”, and “secure” shall be understood in a broad sense. For example, a connection may be a fixed connection, or may be a detachable connection, or may indicate integration into a whole; may be a mechanical connection, or may be an electrical connection; may be a direct connection, or may be an indirect connection via a medium; and may be inner communication between two elements or an interaction relationship between two elements, unless otherwise clearly limited. A person of ordinary skill in the art can understand specific meanings of the foregoing terms in the present disclosure according to specific situations.

In the present disclosure, unless otherwise clearly specified and limited, that a first feature is “on” or “under” a second feature may indicate that the first and second features are in direct contact or the first and second features are in indirect contact via a medium. Besides, that the first feature is “on”, “above”, or “on the top of” the second feature may indicate that the first feature is right or obliquely “on”, “above”, or “on the top of” the second feature, or merely indicate that a horizontal level of the first feature is higher than that of the second feature. That the first feature is “under”, “blow”, or “on the bottom of” the second feature may indicate that the first feature is right or obliquely “under”, “blow”, or “on the bottom of” the second feature, or merely indicate that a horizontal level of the first feature is lower than that of the second feature.

The following describes the present disclosure in detail with reference to the accompanying drawings and embodiments.

An internal gear pump 1000 adopts the principle of internal gear meshing. A gear pair 200 of the internal gear pump 1000 includes a gear shaft 220 and an annular gear 210. The gear shaft 220 drives the annular gear 210 to rotate in the same direction as the gear shaft 220. The gear shaft 220 and the annular gear 210 are separated from each other at an entrance of the internal gear pump 1000, to generate a negative pressure, thereby sucking in a liquid. An area at the entrance of the internal gear pump 1000 is configured as a low-pressure oil area II. The gear shaft 220 and the annular gear 210 continuously mesh with each other at an exit of the internal gear pump 1000, to press out the liquid, and thus an area at the exit of the internal gear pump 1000 is configured as a high-pressure oil area I.

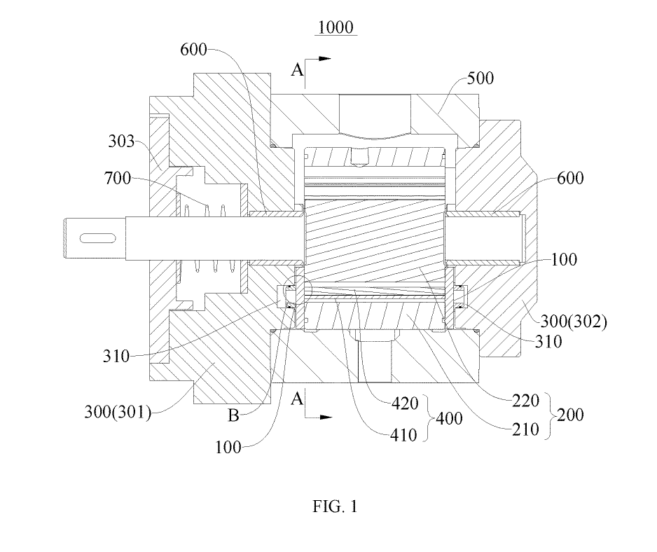

An axial compensation component 100 for the internal gear pump 1000 according to an embodiment of the present disclosure is first described in detail with reference to FIG. 1 to FIG. 11.

As shown in FIG. 1 to FIG. 11, the internal gear pump 1000 includes a pump cover 300, the axial compensation component 100 is configured to be sandwiched between the pump cover 300 of the internal gear pump 1000 and the gear pair 200, to separate the pump cover 300 from the gear pair 200, thereby preventing abrasion generated between the gear pair 200 and the pump cover 300. An oil storage tank 310 is formed in the pump cover 300. The oil storage tank 310 is configured to be in communication with the high-pressure oil area I of the internal gear pump 1000, that is, the oil storage tank 310 contains high pressure oil. The axial compensation component 100 includes a floating side plate 110 and a floating sleeve 120. The floating sleeve 120 is fixed at a side, which is far away from the gear pair 200, of the floating side plate 110. A part of floating sleeve 120 is configured to extend into the oil storage tank 310 of the pump cover 300.

The floating sleeve 120 is configured to press the floating side plate 110 tightly against the gear pair 200 under an oil pressure of the high pressure oil in the oil storage tank 310. When the internal gear pump 1000 works, the floating side plate 110 thins due to continuous abrasion against the gear pair 200, and the high pressure oil in the oil storage tank 310 can push the floating sleeve 120 to move towards the gear pair 200, so that the floating side plate 110 can press tightly against the gear pair 200 all the time. In this way, the axial compensation component 100 for the internal gear pump 1000 has a greatly increased axial compensation range, can achieve axial compensation for a relatively large gap, and is easy to assemble.

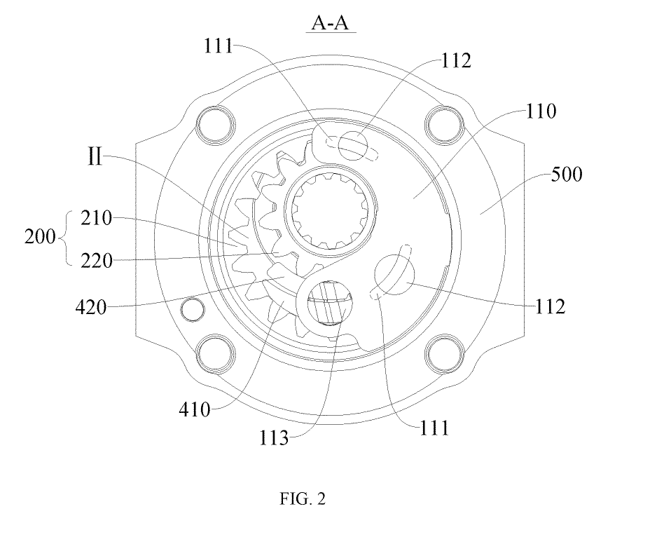

To simplify the structure of the internal gear pump 1000, the oil storage tank 310 may be in communication with the high-pressure oil area I of the internal gear pump 1000 via the axial compensation component 100. Specifically, as shown in FIG. 2 to FIG. 9, a guide groove 111 may be formed in a side, which faces the gear pair 200, of the floating side plate 110. The guide groove 111 is configured to be in communication with the high-pressure oil area I of the internal gear pump 1000. An installation groove 112 may be formed in a side, which faces the floating sleeve 120, of the floating side plate 110. A part of the floating sleeve 120 may be disposed in the installation groove 112 via an interference fit. The floating sleeve 120 may be provided with a through hole 123 running through the floating sleeve 120 along an axial direction thereof. The through hole 123 may be in communication with the guide groove 111.

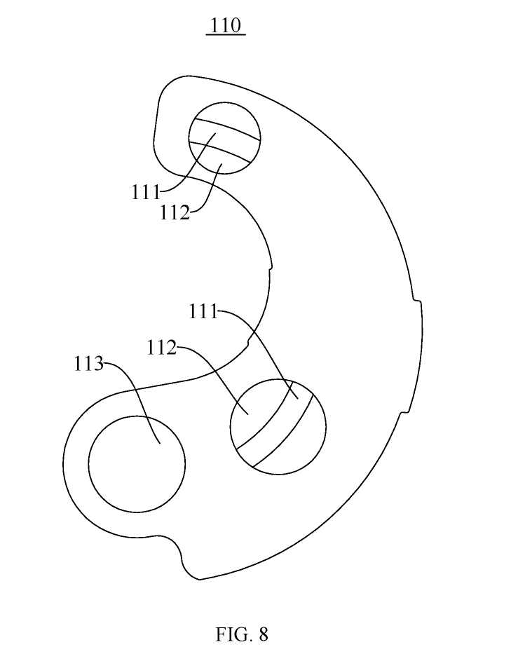

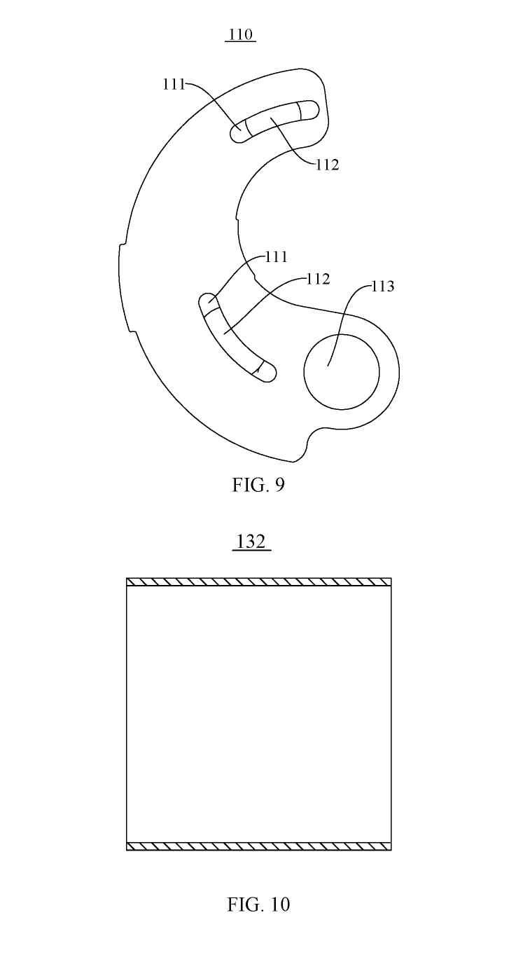

It can be understood that as shown in FIG. 8 to FIG. 9, at least a part of the guide groove 111 of the floating side plate 110 and the installation groove 112 can together run through the floating side plate 110. In this way, two ends of the through hole 123 of the floating sleeve 120 can be respectively in communication with the oil storage tank 310 and the guide groove 111. Therefore, the oil storage tank 310 is in communication with the high-pressure oil area I of the internal gear pump 1000. The guide groove 111 has a function of slowing down the high pressure oil in the high-pressure oil area I, and the interference fit between the floating sleeve 120 and the installation groove 112 can further prevent the high pressure oil from leaking off between the floating sleeve 120 and the floating side plate 110. Under the oil pressure of the high pressure oil in the oil storage tank 310, the floating sleeve 120 pushes the floating side plate 110 connected to the floating sleeve 120 to press tightly against the gear pair 200 all the time, thereby implementing the axial compensation.

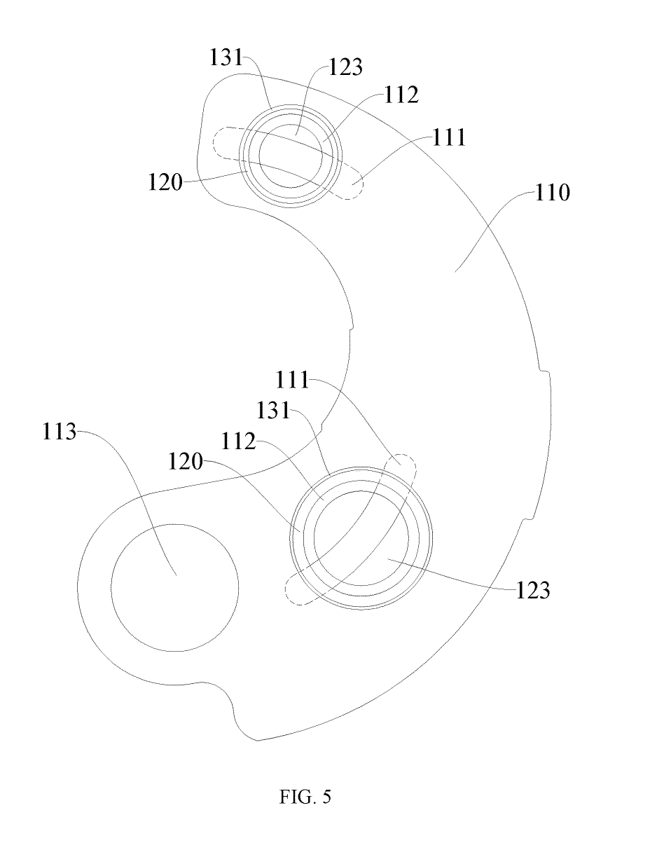

In a specific example of the present disclosure, as shown in FIG. 2, FIG. 5, FIG. 8 and FIG. 9, the guide groove 111 may be configured as a waist-shaped groove. According to a shape of the high-pressure oil area I, the waist-shaped groove can be in better communication with the high-pressure oil area I.

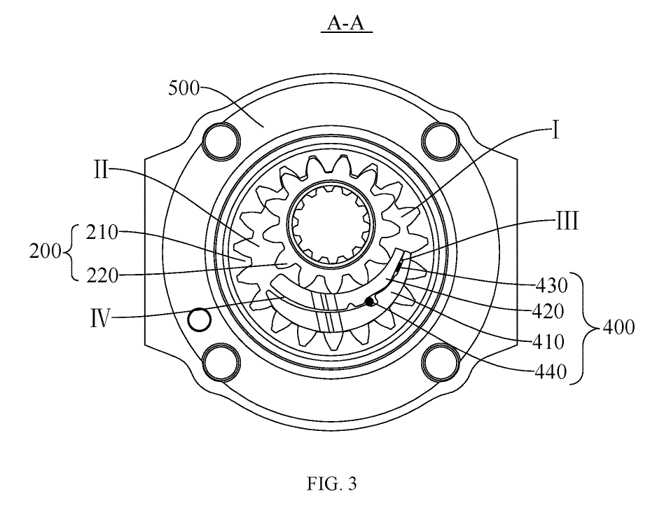

As shown in FIG. 2, FIG. 3, FIG. 5, FIG. 8 and FIG. 9, according to a shape of the gear pair 200, the floating side plate 110 may be configured as an arc-shaped plate, so that the floating side plate 110 can better separate the gear pair 200 from the pump cover 300.

The floating side plate 110 presses tightly against the gear pair 200 based on the floating sleeve 120. In order that the floating side plate 110 and the gear pair 200 abut against each other more closely, a plurality of floating sleeves 120 may be provided, and the plurality of floating sleeves 120 may be arranged and spaced apart from each other along a circumferential direction of the arc-shaped plate. Correspondingly, a plurality of guide grooves 111 and a plurality of installation grooves 112 in one-to-one correspondence with the plurality of floating sleeves 120 may be provided in the floating side plate 110, in which one installation groove 112 corresponds to one guide groove 111.

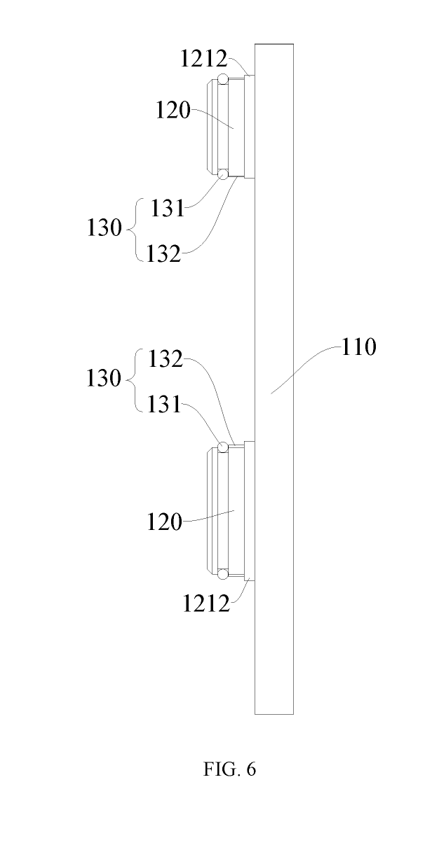

In a specific example of the present disclosure, as shown in FIG. 2, FIG. 5, FIG. 6, FIG. 8 and FIG. 9, two installation grooves 112 and two guide grooves 111 are formed in the floating side plate 110, in which the two installation grooves 112 and the two guide grooves 111 are arranged and spaced apart from each other along the circumferential direction of the arc-shaped plate. Correspondingly, two floating sleeves 120 are provided and respectively disposed in the two installation grooves 112 via the interference fit. Therefore, force applied on the floating side plate 110 is more even, and abrasion of parts of the floating side plate 110 is more uniform, which thus can prolong the service life of the axial compensation component 100.

Preferably, the floating side plate 110 may be made of copper alloy, for example, alloy of copper, aluminum and zinc.

Preferably, the floating sleeve 120 may be made of stainless steel.

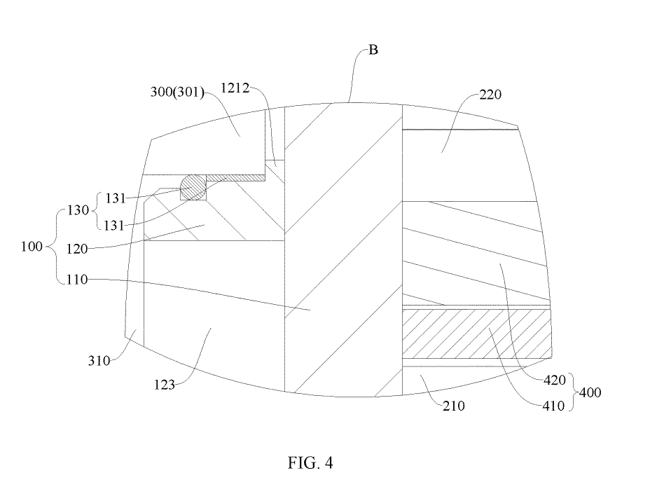

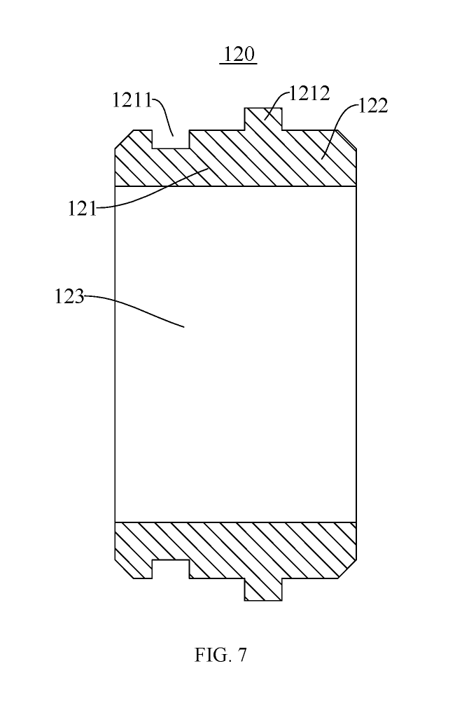

As shown in FIG. 7, the floating sleeve 120 may include an installation part 122 and a support part 121. A first end of the support part 121 is connected to the installation part 122, and a second end of the support part 121 is configured to extend into the oil storage tank 310. The installation part 122 is disposed in the installation groove 112 of the floating side plate 110 via the interference fit, and the through hole 123 of the floating sleeve 120 runs through the installation part 122 and the support part 121. As shown in FIG. 4 and FIG. 7, an installation boss 1212 that protrudes radially outward is arranged on an outer circumferential wall of the support part 121, and a side of the installation boss 1212 abuts against the floating side plate 110.

It can be understood that the oil pressure of the high pressure oil in the oil storage tank 310 is directly applied to the second end of the support part 121 of the floating sleeve 120, so as to press the floating side plate 110 tightly against the gear pair 200. As shown in FIG. 4 to FIG. 7, a seal component 130 is disposed between an inner circumferential wall of the oil storage tank 310 and the support part 121. The seal component 130 can seal a gap between the inner circumferential wall of the oil storage tank 310 and the support part 121, so as to prevent leakage of the high pressure oil in the oil storage tank 310.

Specifically, as shown in FIG. 4, the seal component 130 includes a seal ring 131 and a seal sleeve 132. A groove 1211 that is recessed radially inward may be formed in the outer circumferential wall of the support part 121. The seal ring 131 may be arranged in the groove 1211, and configured to elastically abut against the inner circumferential wall of the oil storage tank 310. The seal sleeve 132 may be sleeved on the support part 121 and configured to elastically abut against the inner circumferential wall of the oil storage tank 310. The seal sleeve 132 may be sandwiched between the seal ring 131 and the installation boss 1212. In other words, one end of the seal sleeve 132 abuts against another side of the installation boss 1212, and the other end of the seal sleeve 132 abuts against the seal ring 131. By means of sealing functions of the seal ring 131 and the seal sleeve 132, the high pressure oil in the oil storage tank 310 is prevented from leaking off between the floating sleeve 120 and the oil storage tank 310.

Preferably, the seal ring 131 is an O-shaped seal ring, and the O-shaped seal ring may be a standard element. Therefore, the seal ring 131 does not need to be manufactured through making molds, which can reduce a processing cost and a processing cycle of the axial compensation component 100.

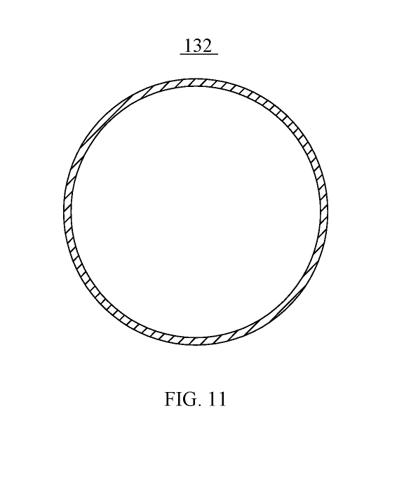

As shown in FIG. 10 and FIG. 11, the seal sleeve 132 may be directly manufactured by high polymer plastics having relatively high elasticity through machining. Therefore, the seal sleeve 132 does not need to be manufactured through making molds, which can further reduce the processing cost and the processing cycle of the axial compensation component 100. Preferably, the seal sleeve 132 is made of high-temperature resistant materials.

Therefore, the seal component 130 has a simple structure and a low manufacturing cost.

In conclusion, the axial compensation component 100 for the internal gear pump 1000 according to the embodiments of the present disclosure is easy to assemble, and the floating sleeve 120 is pushed by means of the oil pressure of the high pressure oil in the internal gear pump 1000, so that the floating side plate 110 connected to the floating sleeve 120 can press tightly against the gear pair 200 all the time, thereby implementing the axial compensation and also satisfying the axial compensation for the relatively large gap. Since the seal component 130 is used, in which the O-shaped seal ring is fitted the seal sleeve 132, the manufacturing cost of the axial compensation component 100 is reduced and the processing cycle thereof also is shortened.

The following describes an internal gear pump 1000 according to an embodiment of the present disclosure with reference to FIG. 1 to FIG. 11.

As shown in FIG. 1 to FIG. 11, the internal gear pump 1000 includes a gear pair 200, a pump cover 300 and an axial compensation component 100. As shown in FIG. 3, the gear pair 200 includes an annular gear 210 and a gear shaft 220 that mesh with each other. A high-pressure oil area I and a low-pressure oil area II are defined between the annular gear 210 and the gear shaft 220. As shown in FIG. 1 and FIG. 4, an oil storage tank 310 is formed in an end face, which faces the gear pair 200, of the pump cover 300.

The axial compensation component 100 is the axial compensation component 100 for the internal gear pump 1000 according to any one of the foregoing embodiments. The axial compensation component 100 includes a floating side plate 110 and a floating sleeve 120. A part of the floating sleeve 120 extends into the oil storage tank 310. The oil storage tank 310 is in communication with the high-pressure oil area I of the internal gear pump 1000. The floating side plate 110 presses tightly against the gear pair 200 under an oil pressure in the oil storage tank 310.

It can be understood that when the internal gear pump 1000 works, the floating side plate 110 thins due to continuous abrasion thereof, and under the oil pressure of high pressure oil in the oil storage tank 310, the floating sleeve 120 pushes the floating side plate 110 connected to the floating sleeve 120 to press tightly against the gear pair 200 all the time, thereby implementing axial compensation. The internal gear pump 1000 in the present disclosure completes the axial compensation by using the high pressure oil to push the floating sleeve 120, and therefore can achieve axial compensation for a relatively large gap. In this way, volumetric efficiency of the internal gear pump 1000 is not affected when the floating side plate 110 has large abrasion, and therefore, a service life of the internal gear pump 1000 is increased. Besides, the axial compensation component 100 of the internal gear pump 1000 is easy to assemble, and thus production efficiency thereof is high.

In a specific embodiment of the present disclosure, as shown in FIG. 1, the internal gear pump 1000 may include a pump body 500 and a sliding bearing 600. The sliding bearing 600 is sleeved on the gear shaft 220 to support the gear shaft 220. The gear shaft 220 and the annular gear 210 may be installed in the pump body 500. The pump cover 300 is installed on the pump body 500.

As shown in FIG. 1, two pump covers 300 are provided. The two pump covers 300 include a front pump cover 301 at a front side of the gear pair 200 and a rear pump cover 302 at a rear side of the gear pair 200, that is, the front pump cover 301 may be installed at a front end of the pump body 500, and the rear pump cover 302 may be installed at a rear end of the pump body 500. Correspondingly, two axial compensation components 100 may be provided. One of the two axial compensation components 100 is arranged between the front pump cover 301 and the front side of the gear pair 200, to separate the front pump cover 301 from the gear pair 200, and the other one of the two axial compensation components 100 is arranged between the rear pump cover 302 and the rear side of the gear pair 200, to separate the rear pump cover 302 from the gear pair 200.

Optionally, as shown in FIG. 1, a small pump cover 303 may be installed at a front end of the front pump cover 301, and a mechanical seal element 700 may be installed between the small pump cover 303 and the front pump cover 301.

Preferably, as shown in FIG. 1 to FIG. 3, the internal gear pump 1000 may include a radial seal compensation component 400. The radial seal compensation component 400 may be arranged between the annular gear 210 and the gear shaft 220, and include an outer crescent member 410, an inner crescent member 420, a spring sheet 430 and a seal bar 440.

The outer crescent member 410 may abut against the annular gear 210. The inner crescent member 420 may abut against the gear shaft 220. A first gap III and a second gap IV may be defined between the outer crescent member 410 and the inner crescent member 420, in which the first gap III may be in communication with the high-pressure oil area I, and the second gap IV may be in communication with the low-pressure oil area II. The seal bar 440 may be configured to have a cylindrical shape. The seal bar 440 may be arranged between the outer crescent member 410 and the inner crescent member 420, to isolate the high-pressure oil area I from the low-pressure oil area II. The spring sheet 430 may be arranged in the first gap III, and two ends of the spring sheet 430 elastically abut against the outer crescent member 410 and the inner crescent member 420 respectively. In this way, under a joint effect of an elastic force of the spring sheet 430 and the oil pressure of the high pressure oil, the outer crescent member 410 can press tightly against the annular gear 210, and the inner crescent member 420 can press tightly against the gear shaft 220. Therefore, radial compensation of the internal gear pump 1000 is implemented.

Preferably, as shown in FIG. 2, FIG. 5, FIG. 8, and FIG. 9, an installation hole 113 may be formed in the floating side plate 110. The radial seal compensation component 400 may be fixed on the floating side plate 110 through a fit between a pin and the installation hole 113, which thus restricts motion of the radial seal compensation component 400, provides a simple structure and facilitates assembling.

In conclusion, according to the internal gear pump 1000 in the embodiments of the present disclosure, the axial compensation component 100 in the internal gear pump 1000 can achieve the axial compensation for the relatively large gap. In this way, volumetric efficiency of the internal gear pump 1000 is not affected when the floating side plate 110 has large abrasion, and therefore, the internal gear pump 1000 has a long service life. Besides, the axial compensation component 100 of the internal gear pump 1000 is easy to assemble, and the production efficiency thereof is high. The radial seal compensation component 400 is easy to assemble and convenient to fix.

The following describes a forklift according to an embodiment of the present disclosure.

As shown in FIG. 1 to FIG. 11, the forklift includes the internal gear pump 1000 according to any one of the foregoing embodiments.

According to the forklift in the embodiment of the present disclosure, the internal gear pump 1000 of the forklift has a large axial compensation range, whereby the internal gear pump 1000 has a long service life, and the forklift has high production efficiency and is not easy to damage.

In the descriptions of this specification, a description made with reference to terms such as “an embodiment”, “some embodiments”, “an example”, “a specific example”, and “some examples” indicates that a specific feature, structure, material, or characteristic described with reference to this embodiment or example is included in at least one embodiment or example of the present disclosure. In this specification, schematic descriptions of the foregoing terms are not necessarily intended for the same embodiment or example. Besides, described specific features, structures, materials, or characteristics may be combined in a proper manner in any one or more embodiments or examples. In addition, a person skilled in the art can merge and combine different embodiments or examples described in this specification and different features of the embodiments or examples, as long as no contradiction is caused.

Although the embodiments of the present disclosure are already shown and described in the foregoing, it can be understood that the foregoing embodiments are exemplary and shall not be understood as limitations on the present disclosure, and a person of ordinary skill in the art can make alterations, modifications, replacements, and variations on the foregoing embodiments without departing from the scope of the present disclosure.

1.-17. (canceled)

18. An axial compensation component for an internal gear pump, configured to be sandwiched between a pump cover of the internal gear pump and a gear pair of the internal gear pump, the axial compensation component comprising:
a floating side plate; and
a floating sleeve fixed on a side of the floating side plate away from the gear pair,
wherein a portion of the floating sleeve is configured to extend into an oil storage tank of the pump cover, the oil storage tank is configured to be in communication with a high-pressure oil region of the internal gear pump, and the floating side plate is configured to press tightly against the gear pair under an oil pressure in the oil storage tank.

19. The axial compensation component according to claim 18, wherein:
a guide groove configured to be in communication with the high-pressure oil region of the internal gear pump is formed in a side of the floating side plate facing the gear pair, and an installation groove is formed in a side of the floating side plate facing the pump cover; and
a portion of the floating sleeve is disposed in the installation groove via an interference fit, the floating sleeve is provided with a through hole running through the floating sleeve along an axial direction thereof, and the through hole is in communication with the guide groove.

20. The axial compensation component according to claim 19, wherein the floating sleeve comprises:
an installation part disposed in the installation groove via the interference fit; and
a support part having a first end connected to the installation part and a second end extending into the oil storage tank.

21. The axial compensation component according to claim 20, wherein a seal component is disposed between an inner circumferential wall of the oil storage tank and the support part to seal a gap therebetween.

22. The axial compensation component according to claim 21, wherein:
a groove that is recessed radially inward and an installation boss that protrudes radially outward are provided at an outer circumferential wall of the support part, and a side of the installation boss abuts against the floating side plate; and
the seal component comprises:
a seal ring disposed in the groove; and
a seal sleeve disposed on the support part and sandwiched between the seal ring and the installation boss.

23. The axial compensation component according to claim 22, wherein the seal ring includes an O-shaped seal ring.

24. The axial compensation component according to claim 17, wherein the floating side plate is configured as an arc-shaped plate, a plurality of floating sleeves are arranged along a circumferential direction of the arc-shaped plate.

25. An internal gear pump, comprising:
a gear pair including an annular gear and a gear shaft meshed with the annular gear and defining a high-pressure oil region and a low-pressure oil region between the annular gear and the gear shaft;
a pump cover having an oil storage tank formed in an end face of the pump cover facing the gear pair; and
an axial compensation component configured to be sandwiched between the pump cover and the gear pair, the axial compensation component further comprising:
a floating side plate; and
a floating sleeve fixed on a side of the floating side plate away from the gear pair,
wherein a portion of the floating sleeve extends into the oil storage tank, the oil storage tank is in communication with the high-pressure oil region of the internal gear pump, and the floating side plate presses tightly against the gear pair under an oil pressure in the oil storage tank.

26. The internal gear pump according to claim 25, further comprising:
two pump covers, the two pump covers including a front pump cover disposed at a front side of the gear pair and a rear pump cover disposed at a rear side of the gear pair; and
two axial compensation components, one of the two axial compensation components being disposed between the front pump cover and the front side of the gear pair, and the other thereof being disposed between the rear pump cover and the rear side of the gear pair.

27. The internal gear pump according to claim 25, further comprising:
a radial seal compensation component disposed between the annular gear and the gear shaft, wherein the radial seal compensation component comprises:
an outer crescent member abutting against the annular gear;
an inner crescent member abutting against the gear shaft, wherein a first gap in communication with the high-pressure oil region and a second gap in communication with the low-pressure oil region are defined between the outer crescent member and the inner crescent member;
a spring sheet disposed in the first gap and having two ends elastically abutting against the outer crescent member and the inner crescent member respectively; and
a seal bar having a cylindrical shape and disposed between the outer crescent member and the inner crescent member to isolate the high-pressure oil region from the low-pressure oil region.

28. The internal gear pump according to claim 25, wherein:
a guide groove configured to be in communication with the high-pressure oil region of the internal gear pump is formed in a side of the floating side plate facing the gear pair, and an installation groove is formed in a side of the floating side plate facing the pump cover; and
a portion of the floating sleeve is disposed in the installation groove via an interference fit, the floating sleeve is provided with a through hole running through the floating sleeve along an axial direction thereof, and the through hole is in communication with the guide groove.

29. The internal gear pump according to claim 28, wherein the floating sleeve comprises:
an installation part disposed in the installation groove via the interference fit; and
a support part having a first end connected to the installation part and a second end extending into the oil storage tank.

30. The internal gear pump according to claim 29, wherein a seal component is disposed between an inner circumferential wall of the oil storage tank and the support part to seal a gap therebetween.

31. The internal gear pump according to claim 30, wherein:
a groove that is recessed radially inward and an installation boss that protrudes radially outward are provided at an outer circumferential wall of the support part, and a side of the installation boss abuts against the floating side plate; and
the seal component comprises:
a seal ring disposed in the groove; and
a seal sleeve disposed on the support part and sandwiched between the seal ring and the installation boss.

32. The internal gear pump according to claim 31, wherein the seal ring includes an O-shaped seal ring.

33. The internal gear pump according to claim 25, wherein the floating side plate is configured as an arc-shaped plate, a plurality of floating sleeves are arranged along a circumferential direction of the arc-shaped plate.

34. A forklift, comprising an internal gear pump, wherein the internal gear pump comprises:
a gear pair including an annular gear and a gear shaft meshed with the annular gear and defining a high-pressure oil region and a low-pressure oil region between the annular gear and the gear shaft; a pump cover having an oil storage tank formed in an end face of the pump cover facing the gear pair; and
an axial compensation component configured to be sandwiched between the pump cover and the gear pair, the axial compensation component further comprising:
a floating side plate; and
a floating sleeve fixed on a side of the floating side plate away from the gear pair,
wherein a portion of the floating sleeve extends into the oil storage tank, the oil storage tank is in communication with the high-pressure oil region of the internal gear pump, and the floating side plate presses tightly against the gear pair under an oil pressure in the oil storage tank.
